(19) United States
(12) Patent Application Publication
(10) Pub. No.: US 2026/0124837 A1
(43) Pub. Date: May 7, 2026

(54) GAS BUFFER TYPE MICRO INK STORAGE DEVICE AND INK-JET PRINTER INCLUDING SAME

(71) Applicant: GOSANTECH CO., LTD., Cheonan-si (KR)

(72) Inventors: Daigeon YOON, Cheonan-si (KR); Dongkyun SHIN, Cheonan-si (KR); Hyunbin PARK, Cheonan-si (KR); Youngho JUNG, Cheonan-si (KR); Seung Ryeol LEE, Cheonan-si (KR); Sooyeon LIM, Cheonan-si (KR)

(73) Assignee: GOSANTECH CO., LTD., Cheonan-si (KR)

(21) Appl. No.: 19/056,910

(22) Filed: Feb. 19, 2025

(30) Foreign Application Priority Data
Nov. 6, 2024 (KR) 10-2024-0155908

(51) Int. Cl. B41J 2/175

(52) U.S. Cl. CPC B41J 2/17596

(57) ABSTRACT

An ink storage device is proposed. The ink storage device is provided to store ink supplied to an inkjet head of an inkjet printer, and includes an ink storage unit, a gas buffer unit connected to the ink storage unit and a gas pressure control device, a gas valve adjusting connection between the ink storage unit and the gas buffer unit, a supply tube supplying ink in the ink storage unit to the inkjet head, a head valve adjusting connection between the ink storage unit and the inkjet head, an injection tube injecting ink into the ink storage device, and an injection valve opening and closing the injection tube. The ink storage unit and the gas buffer unit are separated from each other, so even when an ink storage space is tiny, the meniscus state can be maintained with the gas pressure control device applying sufficient negative pressure.

### CROSS REFERENCE TO RELATED APPLICATION

The present application claims priority to Korean Patent Application No. 10-2024-0155908, filed Nov. 6, 2024, the entire contents of which are incorporated herein for all purposes by this reference.

### BACKGROUND OF THE INVENTION

### Field of the Invention

The present disclosure relates to an ink storage device and an inkjet printer including the same. More particularly, the present disclosure relates to a micro-ink storage device for an inkjet printer, which stores and uses a small amount of ink, and an inkjet printer including the same.

### Description of the Related Art

In general, inkjet printing technology sprays liquid ink in a form of droplets on a surface of a medium according to a shape signal. The inkjet printing technology creates patterns directly by spraying small volumes of droplets on a print object at a frequency of hundreds of times per second or more, by using electricity, magnetic force, or pneumatic pressure.

This inkjet printing technology originated in the field of publishing printing to produce documents and advertisements, and has been increasingly used in industrial fields due to the ability to form highly precise droplet patterns. Specifically, in semiconductor and display fields, inkjet printing is used in a wide application range, such as forming complicated shape patterns on substrates or in solution processes of precisely dispensing ink in specific locations, and there is an effort to apply inkjet printing to create small, precise patterns in a variety of electronic devices.

In order to eject ink by a precise amount in the inkjet printing process, ink in preparation for ejection in in the inkjet head should be maintained in a meniscus state, in which the ink has a concave surface due to capillary action at a nozzle inlet. To this end, the ink storage device is located higher than an inkjet head, whereby negative pressure is created in an ink storage tank to prevent ink from flowing down in the inkjet head, thereby maintaining the meniscus state.

When the gas pressure control device does not maintain the meniscus state for the inkjet head through an ink storage unit, the precision of inkjet printing is reduced, or ink leaks from a nozzle of the inkjet head to cause contamination, interrupting inkjet printing and shutting down the entire production facility. Therefore, controlling gas pressure, which is performed in the ink storage unit to apply negative pressure to ink filled in the inkjet nozzle over the ink storage unit, is a very important part of an inkjet printing process.

Meanwhile, in recent years, as application fields of inkjet printing have widened, configurations have been developed to apply inkjet printing to application fields that use very small amounts of ink. The recent industrial inkjet printing device has been developed into a form suitable for mass production while maintaining a basic characteristic of inkjet printing, which is precision, and the development has been made by providing an ink storage device for supplying ink to a head with a large capacity or constantly supplying ink to the ink storage device for supplying ink to a head. However, recently, as the industrial atmosphere of small-item mass production has changed to the industrial atmosphere of multi-product small-lot production, new requirements are required for the industrial inkjet printer. In the past, the main purpose was to perform a single process repeatedly for a long time using one type of ink in one industrial inkjet printer, but recently, there has been an increasing need for industrial devices that print extremely small amounts of ink and for performing inkjet printing while storing a small amount of ink due to properties of ink.

Specifically, recently, there has been a growing demand for bio sensors and bio kits, such as diagnostic kits to check infectious diseases or check diagnose diseases, or test kits to check allergic reactions. Attempts have been made to apply inkjet printing to the manufacturing process for theses kits. However, while the manufacturing process of bio sensors and bio kits consumes a very small amount of ink per process, the ink used is perishable, so the amount of ink that can be stored at a time is very small. Therefore, it is difficult to apply currently developed inkjet printers. Specifically, compared to the storage capacity of currently developed inkjet printers, storage devices such as bio kits, etc. can only store a small amount of ink at a time, so normal inkjet printing cannot be performed, and simply reduction of the size of the ink storage device is not enough to control the meniscus state. Moreover, since the amount of ink stored in the storage device is very small, it is difficult to inject ink into the inkjet head initially or to continuously inject ink into the inkjet head during a purge process to remove internal air.

### DOCUMENT OF RELATED ART

### Patent Documents

(Patent Document 1) Korean Patent Publication

Application No. 10-2021-0070281

### SUMMARY OF THE INVENTION

The present disclosure is provided to solve the problems of the related art mentioned above, an objective of the present disclosure is to provide a micro-ink storage device and an inkjet printer, the micro-ink storage device being configured to store an extremely small amount of ink, easily control negative pressure, and easily inject ink.

In order to achieve the above-described objective, according to an aspect of the present disclosure, there is provided a gas buffer-type micro-ink storage device storing ink supplied to an inkjet head of an inkjet printer, the ink storage device including: an ink storage unit storing ink; a gas buffer unit that is connected to the ink storage unit with a gas connection tube through which gas flows, and connected to a gas pressure control device with a pressure control tube so that the gas pressure control device may provide a gas volume to adjust gas pressure; a gas valve that is enabled to adjust connection between the ink storage unit and the gas buffer unit; a supply tube configured to supply the ink stored in the ink storage unit to the inkjet head; a head valve configured to adjust connection between the ink storage unit and the inkjet head; an injection tube configured to inject ink into the ink storage device; and an injection valve configured to open and close the injection tube, wherein the injection tube may be connected to the supply tube or at least to a portion where the supply tube and the ink storage unit are connected to each other, and according to operation of the head valve, ink injected into the injection tube does not flow into the ink storage unit but is injected into the inkjet head.

In the supply tube, the head valve may be installed to a position close to the inkjet head rather than a position to which the injection tube is connected, and the head valve may be a 2-way valve.

When ink is injected through the injection tube with the head valve closed, the ink injected into the injection tube may be injected into the ink storage unit, and when ink is injected through the injection tube with the head valve opened and the gas valve closed, the ink injected into the injection tube does not flow into the ink storage unit but may be injected into the inkjet head.

In the supply tube, the head valve may be installed at a position to which the injection tube is connected, and the head valve may be a 3-way valve.

When the head valve connects the injection tube and the ink storage unit to each other, ink injected into the injection tube may be injected into the ink storage unit, and when the head valve connects the injection tube and the inkjet head to each other, the ink injected into the injection tube does not flow into the ink storage unit but may be injected into the inkjet head.

The gas buffer-type micro-ink storage device may further include: an ink discharge tube configured to discharge ink flowing into the gas buffer unit outward, and a discharge valve configured to open and close the ink discharge tube.

According to another aspect of the present disclosure, there is provided an inkjet printer including a gas buffer-type micro-ink storage device, the inkjet printer including an inkjet head, a micro-ink storage device configured to supply ink to the inkjet head, and a gas pressure control device configured to control gas pressure in the micro-ink storage device, wherein the micro-ink storage device may be a gas buffer-type micro-ink storage device comprising: an ink storage unit storing ink; a gas buffer unit that is connected to the ink storage unit with a gas connection tube through which gas flows, and connected to the gas pressure control device with a pressure control tube so that the gas pressure control device may provide a gas volume to adjust gas pressure; a gas valve that is enabled to adjust connection between the ink storage unit and the gas buffer unit; a supply tube configured to supply the ink stored in the ink storage unit to the inkjet head; a head valve configured to adjust connection between the ink storage unit and the inkjet head; an injection tube configured to inject ink into the ink storage device; and an injection valve configured to open and close the injection tube, wherein the injection tube may be connected to the supply tube or at least to a portion where the supply tube and the ink storage unit are connected to each other, and according to operation of the head valve, ink injected into the injection tube does not flow into the ink storage unit but may be injected into the inkjet head.

In the supply tube, the head valve may be installed at a position close to the inkjet head rather than a position to which the injection tube is connected, and the head valve may be a 2-way valve.

When ink is injected through the injection tube with the head valve closed, the ink injected into the injection tube may be injected into the ink storage unit, and when ink is injected through the injection tube with the head valve opened and the gas valve closed, the ink injected into the injection tube does not flow into the ink storage unit but may be injected into the inkjet head.

In the supply tube, the head valve may be installed at a position to which the injection tube is connected, and the head valve may be a 3-way valve.

When the head valve connects the injection tube and the ink storage unit to each other, the ink injected into the injection tube may be injected into the ink storage unit, and when the head valve connects the injection tube and the inkjet head to each other, the ink injected into the injection tube does not flow into the ink storage unit but may be injected into the inkjet head.

The inkjet printer may further include: an ink discharge tube configured to discharge ink flowing into the gas buffer unit outward, and a discharge valve configured to open and close the ink discharge tube.

According to the present disclosure as described above, the ink storage unit and the gas buffer unit are separated from each other, so even when the ink storage space is tiny, the meniscus state can be maintained with the gas pressure control device applying sufficient negative pressure.

Furthermore, the process of injecting ink into the inkjet head can be easily performed, so it is possible to overcome the problem that it is difficult to inject ink into the inkjet head in the conventional structure in which the inkjet head is filled only with ink stored in the ink storage unit.

### BRIEF DESCRIPTION OF THE DRAWINGS

FIG. 1 is a view illustrating a structure of a gas buffer-type micro-ink storage device according to an embodiment of the present disclosure.

FIG. 2 is a view showing the gas buffer-type micro-ink storage device according to the embodiment of the present disclosure to which a syringe is connected to inject ink.

FIG. 3 is a schematic view showing a structure of the gas buffer-type micro-ink storage device according to the embodiment of the present disclosure.

FIG. 4 is a view illustrating an operation of each valve in a process of injecting ink into an ink storage unit from the schematic view shown in FIG. 3.

FIG. 5 is a view illustrating an operation of each valve in a process of directly supplying ink to the inkjet head from the schematic view shown in FIG. 3.

FIG. 6 is a view illustrating an operation of each valve in a process of performing inkjet printing from the schematic view shown in FIG. 3.

FIG. 7 is a schematic view showing another structure of the gas buffer-type micro-ink storage device according to the embodiment of the present disclosure.

FIG. 8 is a view illustrating an operation of each valve in a process of injecting ink into an ink storage unit from the schematic view shown in FIG. 7.

FIG. 9 is a view illustrating an operation of each valve in a process of directly supplying ink to the inkjet head from the schematic view shown in FIG. 7.

FIG. 10 is a view illustrating an operation of each valve in a process of performing inkjet printing from the schematic view shown in FIG. 7.

### DETAILED DESCRIPTION OF THE DISCLOSURE

An exemplary embodiment according to the present disclosure will be described in detail with reference to accompanying drawings.

However, various changes to the following embodiments are possible and the scope of the present disclosure is not limited to the following embodiments. In these drawings, the shapes and sizes of elements may be exaggerated for explicit description, and the same reference numerals are used throughout the different drawings to designate the same or similar components.

As used herein, it will be understood that when an element is referred to as being “coupled” or “connected” to another element, it can be directly coupled or connected to the other element or electrically coupled or connected thereto with intervening elements that may be present therebetween. Furthermore, unless the context clearly indicates otherwise, it will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof.

Terms such as “first” and “second” are used only for the purpose of distinguishing a constitutive element from another constitutive element, but the constitutive elements should not be limited to these terms. For example, a first constitutive element may be referred to as a second constitutive element, and the second constitutive element may also be referred to as the first constitutive element.

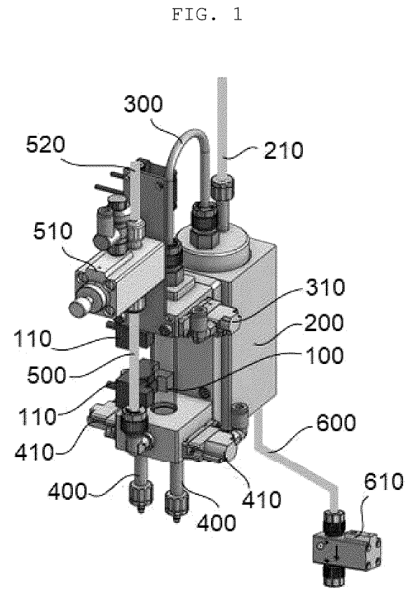

FIG. 1 is a view illustrating a structure of a gas buffer-type micro-ink storage device according to an embodiment of the present disclosure.

A gas buffer-type micro-ink storage device of an embodiment includes: an ink storage unit 100, a gas buffer unit 200, a gas connection tube 300, a gas valve 310, a pressure control tube 210, a supply tube 400, a head valve 410, an injection tube 500, an injection valve 510, and an ink discharge tube 600.

The ink storage unit 100 is the space to store ink to be injected into an inkjet head.

The ink storage unit 100 in the embodiment may be specifically configured to be suitable for a purpose of storing a specialized ink used to manufacture a bio kit, etc., such as a bio sensor. To this end, the ink storage unit of the present disclosure has a smaller storage capacity (e.g., less than or equal to 10 cc) than ink storage devices used in typical industrial inkjet printers.

However, in this process, due to lack of the storage space of the ink storage unit 100, there may be a problem with pressure control to the ink storage unit 100 and the inkjet head connected to the ink storage unit 100. This pressure control may be the essential configuration to discharge a precise amount of ink. To ensure that ink ready to be ejected at the inkjet head remains in the meniscus with a curved surface that is drawn inward by capillary action based on a nozzle inlet, a gas pressure control device, which is called a meniscus pressure controller (MPC) is connected to the ink storage unit to apply negative pressure to a space connecting the ink storage unit 100 to the inkjet head. At this point, in the process of the gas pressure control device applying negative pressure to the space connecting the ink storage unit 100 to the inkjet head, an inner space equal to or greater than a predetermined volume is required. The present disclosure has a problem in that the ink storage unit 100 does not have the level of the inner volume required by the gas pressure control device due to a small size of the ink storage unit.

The gas buffer unit 200 is a constitutive element added to provide the inner space equal to or greater than a predetermined volume that is not provided by the ink storage unit 100 and necessary to operate the gas pressure control device.

The gas buffer unit 200 is connected to the ink storage unit 100 through the gas connection tube 300 and connected to the gas pressure control device (not shown) through the pressure control tube 210, and the gas pressure control device is not particularly limited as long as it provides a sealed space to control gas pressure. The size of the gas buffer unit 200 is preset based on a volume required by the gas pressure control device to control gas pressure.

The gas connection tube 300 is installed between the ink storage unit 100 and the gas buffer unit 200 and connects the ink storage unit 100 and the gas buffer unit 200 to each other so that gas flows between the ink storage unit 100 and the gas buffer unit 200.

The gas valve 310 is a valve that can adjust a connection between the ink storage unit 100 and the gas buffer unit 200 through the gas connection tube 300.

When the gas valve 310 is closed, not only a flow of gas is blocked between the ink storage unit 100 and the gas buffer unit 200, but also a flow of liquid is blocked, so the gas valve 310 can perform a function of preventing the ink in the ink storage unit 100 from flowing into the gas buffer unit 200.

The pressure control tube 210 connects the gas buffer unit 200 and the gas pressure control device to each other for gas to flow. When the gas pressure control device applies negative pressure, gas flows from the gas buffer unit 200 to the gas pressure control device. When the gas pressure control device applies positive pressure, gas flows from the gas pressure control device to the gas buffer unit 200.

The supply tube 400 is provided to connect the ink storage unit 100 and the inkjet head (not shown) and supply the ink stored in the ink storage unit 100 to the inkjet head. The head valve 410 is a valve that can adjust the connection between the ink storage unit 100 and the inkjet head.

When the head valve 410 is closed, a flow of ink or gas from the ink storage unit 100 to the inkjet head is limited. Moreover, the head valve 410 of the present disclosure adjusts the connection between the injection tube 500 and the ink storage unit 100 and/or the inkjet head. Specifically, the head valve 410 is characterized to perform a function that controls ink injected into the injection tube 500 to flow directly into the inkjet head without flowing into the ink storage unit 100. The configuration for this function will be described with the description of the injection tube 500.

The injection tube 500 is connected to the ink storage device to inject ink into the ink storage device.

A first end of the injection tube 500 may be connected to various components to inject ink. A general industrial inkjet printer is configured to receive a continuous supply of ink by being connected to an external ink tank or the like. The embodiment illustrates a form that injects ink using a syringe to accommodate a small ink storage amount of the micro-ink storage device. Accordingly, a second end of the injection tube 500 includes a syringe coupling part 520.

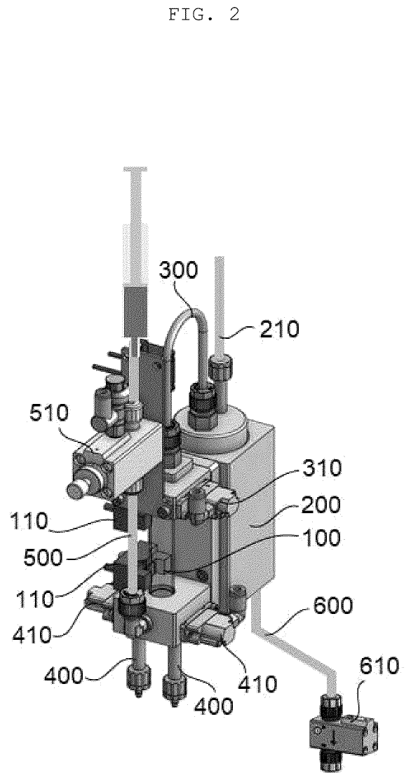

FIG. 2 is a view showing the gas buffer-type micro-ink storage device according to the embodiment of the present disclosure to which a syringe is connected to inject ink.

The injection valve 510 is provided to open and close the injection tube 500.

The injection valve 510 may insulate the ink storage unit 100 from the outside space by closing the injection tube 500. When the injection tube 500 is simply connected to the ink storage unit 100, the ink storage unit 100 and the gas buffer unit 200 are connected to the outside space to cause a problem in control of the internal gas pressure. Therefore, the injection tube 500 is configured to open the injection valve 510 only when ink is injected and to close the injection valve 510 when the inkjet printer is used.

As described above, the present disclosure is characterized in that ink injected into the injection tube 500 flows directly to the inkjet head without flowing into the ink storage unit 100.

To this end, in the embodiment, the injection tube 500 is connected to a portion where the supply tube 400 and the ink storage unit 100 are connected to each other or to the supply tube 400, and configured to allow, according to the movement of the head valve 410, ink flowing out of the injection tube 500 to flow into the supply tube 400 without passing the ink storage unit 100.

At this point, the head valve 410 may be a 3-way valve that can adjust the connection between the injection tube 500 and the ink storage unit 100 and the connection between the injection tube 500 and the inkjet head by itself. As another form, the head valve 410 may be a 2-way valve that can adjust the connection between the injection tube 500 and the ink storage unit 100. In this case, the connection between the injection tube 500 and the inkjet head can be adjusted in conjunction with the gas valve 310. Specific operations will be described later.

The ink discharge tube 600 is connected to an inner bottom surface of the gas buffer unit 200 and discharges ink outward when the ink flows into the gas buffer unit 200.

Although the gas valve 310 prevents ink in the ink storage unit 100 from flowing to the gas buffer unit 200, the gas valve 310 is opened in the ink injecting process or in the operation of the inkjet printer, so there may be a problem of ink flowing to the gas buffer unit 200. At this point, without performing disassembly of the device or the like, ink discharge may be performed through the ink discharge tube 600 connected to the inner bottom surface of the gas buffer unit 200. To maintain the sealing of the gas buffer unit, a discharge valve 610 that can open and close the ink discharge tube 600 is installed.

Furthermore, a level sensor 110 is installed to check the amount of ink stored in the ink storage unit 100.

As described above, to remove the problem of a small volume of the ink storage unit 100, the gas buffer-type micro-ink storage device of the embodiment ensures the internal space required in the gas pressure control device by connecting the gas buffer unit 200 to the ink storage unit 100.

Moreover, ink is conventionally supplied to the inkjet head only through the ink storage unit, but the gas buffer-type micro-ink storage device in the embodiment may be configured such that ink injected into the injection tube may flow directly to the inkjet head through the supply tube by adjusting the head valve.

Hereinbelow, the operation of the gas buffer-type micro-ink storage device according to the embodiment of the present disclosure will be described.

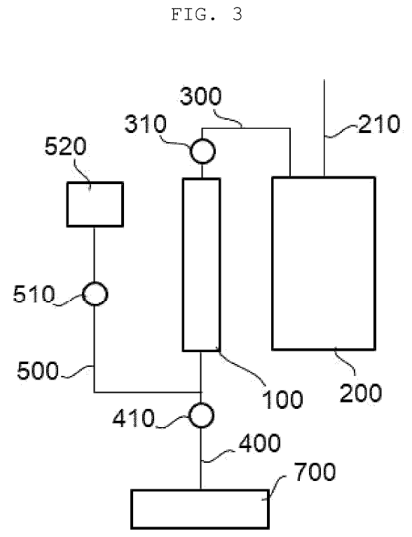

FIG. 3 is a schematic view showing a structure of the gas buffer-type micro-ink storage device according to the embodiment of the present disclosure.

As shown in FIG. 3, the gas buffer-type micro-ink storage device includes the ink storage unit 100, the gas buffer unit 200, the gas connection tube 300, the gas valve 310, the pressure control tube 210, the supply tube 400, the head valve 410, the injection tube 500, and the injection valve 510.

The detailed descriptions of each constitutive element are omitted, and the connection between components will be described.

The gas connection tube 300 is connected to the ink storage unit 100 and the gas buffer unit 200 while being located therebetween, and the gas valve 310 is installed in the gas connection tube 300.

The pressure control tube 210 is connected to the gas buffer unit 200, and the gas pressure control part (not shown) is connected to a second end of the pressure control tube 210.

The supply tube 400 is connected to the ink storage unit 100, and an inkjet head 700 is connected to a second end of the supply tube 400.

A first end of the injection tube 500 is connected to the supply tube 400, and a second end of the injection tube 500 is coupled to the coupling part 520, and the coupling part 520 corresponds to the syringe coupling part described in FIG. 1.

A 2-way valve is installed as the head valve 410 at a position closer to the inkjet head 700 than the portion where the injection tube 500 is connected to the supply tube 400, the injection valve 510 is installed at the injection tube 500.

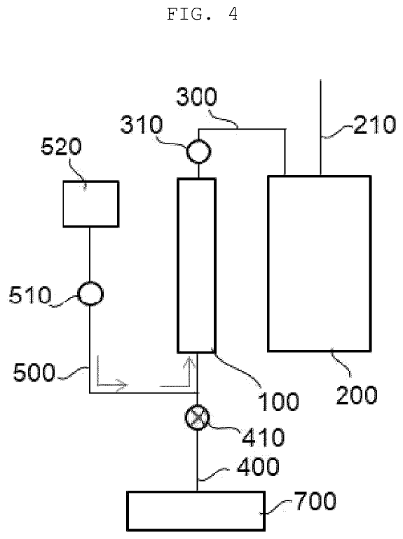

FIGS. 4 to 6 are views illustrating operations of each valve installed in the schematic view shown in FIG. 3.

FIG. 4 is a view illustrating an operation of each valve in a process of injecting ink into an ink storage unit from the schematic view shown in FIG. 3.

FIG. 4 shows an operation that may be performed in an initial preparation process of the inkjet printer or an additional ink injection process to the ink storage unit 100. First, the injection valve 510 is opened for ink to be injected through the injection tube 500.

In order to allow the ink that arrives from the end of the injection tube 500 to the supply tube 400 to flow to the ink storage unit 100 without flowing to the inkjet head 700, the head valve 410 is closed.

In order to prevent a pressure of gas filled in the ink storage unit 100 from interfering the injection of ink, the gas valve 310 is opened.

As described above, ink injected through the injection tube by operations of valves may be filled in the ink storage unit.

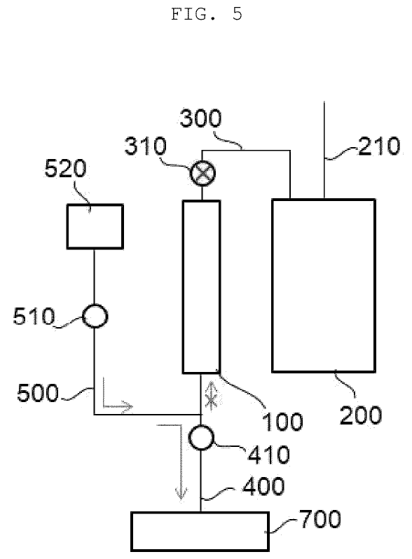

FIG. 5 is a view illustrating an operation of each valve in a process of directly supplying ink to the inkjet head from the schematic view shown in FIG. 3.

FIG. 5 is an operation that may be performed when ink is supplied to the inkjet head 700 in the initial preparation process or purge process of the inkjet printer.

First, the injection valve 510 is opened for ink to be injected through the injection tube 500.

In order to allow the ink that arrives from the end of the injection tube 500 to the supply tube 400 to flow to the inkjet head 700, the head valve 410 is opened.

Furthermore, the pressure of gas filled in the ink storage unit 100 disturbs ink from flowing to the ink storage unit 100 so that the injected ink flows to the inkjet head 700, not the ink storage unit 100.

As described above, ink injected through the injection tube by operations of valves may be filled in the inkjet head.

The initial preparation process of the inkjet printer is performed by, from when an initial state where ink is not completely supplied both the ink storage unit 100 and the inkjet head 700, supplying ink into the ink storage unit 100 and the inkjet head 700.

Conventionally, the initial preparation of the inkjet printer is performed by supplying ink into the ink storage unit 100 first and transferring the ink supplied to the ink storage unit 100 into the inkjet head 700. However, in the case in which the ink storage space is small like the present disclosure, there is a problem in that the process of supplying ink stored in the ink storage unit back into the inkjet printer takes a long time.

As shown in FIG. 5, the present disclosure is configured such that ink injected into the injection tube flows directly to the inkjet head through the supply tube, so a problem caused by a small space in the ink storage unit can be solved.

Meanwhile, both the operations of FIGS. 4 and 5 should be performed in the initial preparation process of the inkjet printer, and the order of the operations is not specified.

Moreover, while the ink storage unit is filled partially by the operation of FIG. 4, ink is supplied to the inkjet head by the operation of FIG. 5, and finally, the operation of FIG. 4 is performed again to fill ink into the ink storage unit. The process of switching into the operation of FIG. 5 from the state when the operation of FIG. 4 is performed to fill the ink storage unit partially may be performed in order of closing the gas valve 310 first and then opening the head valve 410.

Furthermore, the gas buffer-type micro-ink storage device of the present disclosure may be received with ink by using a syringe, and in the process of injecting ink by using a syringe, ink stored in the syringe may be exhausted. In this case, the syringe may be replaced when the injection valve 510 is closed, and in some cases, the syringe may be replaced when all valves are closed.

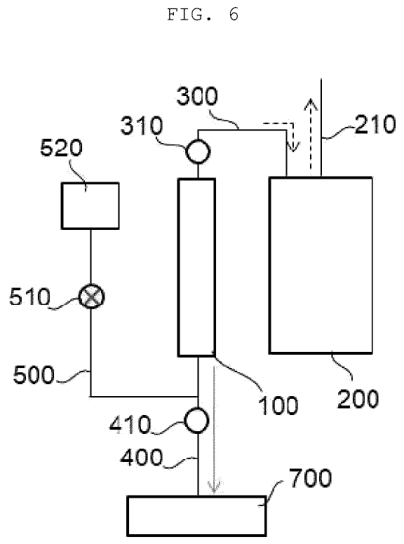

FIG. 6 is a view illustrating an operation of each valve in a process of performing inkjet printing from the schematic view shown in FIG. 3.

First, the injection valve 510 is closed to prevent the ink storage unit 100 from being connected to the outside space through the injection tube 500 and to seal the ink storage unit 100.

The head valve 410 is opened to allow ink in the ink storage unit 100 to flow into the inkjet head 700.

Furthermore, the gas valve 310 is opened so that the gas pressure control part connected to the pressure control tube 210 of the gas buffer unit 200 controls the internal pressure of the ink storage unit 100 and the inkjet head 700.

The operations of the valves as described above allow ink of the ink storage unit to be supplied into the inkjet head, and the gas pressure control device applies negative pressure, performing precise inkjet printing.

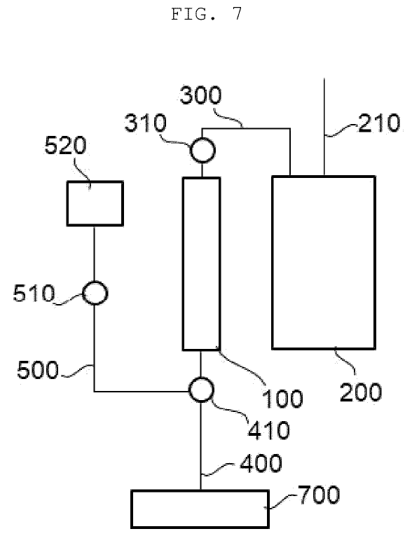

FIG. 7 is a schematic view showing another structure of the gas buffer-type micro-ink storage device according to the embodiment of the present disclosure.

As shown in FIG. 7, the gas buffer-type micro-ink storage device includes the ink storage unit 100, the gas buffer unit 200, the gas connection tube 300, the gas valve 310, the pressure control tube 210, the injection tube 500, the injection valve 510, the supply tube 400, and the head valve 410.

The detailed descriptions of each constitutive element are omitted, and the connection between components will be described.

The gas connection tube 300 is connected to the ink storage unit 100 and the gas buffer unit 200 while being located therebetween, and the gas valve 310 is installed in the gas connection tube 300.

The pressure control tube 210 is connected to the gas buffer unit 200, and the gas pressure control part (not shown) is connected to a second end of the pressure control tube 210.

The supply tube 400 is connected to the ink storage unit 100, and the inkjet head (not shown) is connected to a second end of the supply tube 400.

A first end of the injection tube 500 is connected to the supply tube 400, and a second end of the injection tube 500 is coupled to the coupling part 520, and the coupling part 520 corresponds to the syringe coupling part described in FIG. 1.

A 3-way valve is installed as the head valve 410 at a portion where the supply tube 400 and the injection tube 500 are connected to each other, and the injection valve 510 is installed at the injection tube 500.

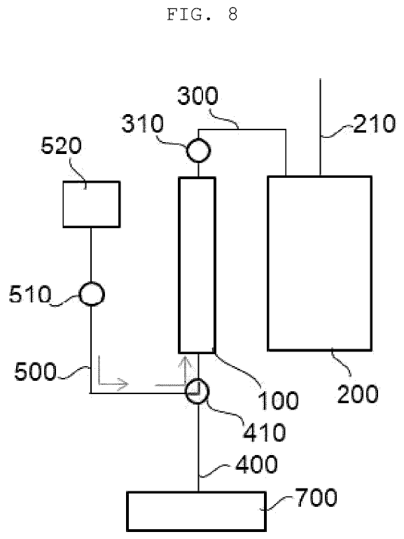

FIGS. 8 to 10 are views illustrating operations of each valve installed in the schematic view shown in FIG. 7.

FIG. 8 is a view illustrating an operation of each valve in a process of injecting ink into an ink storage unit from the schematic view shown in FIG. 7.

FIG. 8 shows an operation that may be performed in an initial preparation process of the inkjet printer or an additional ink injection process to the ink storage unit 100.

First, the injection valve 510 is opened for ink to be injected through the injection tube 500.

In order to allow the ink that arrives from the end of the injection tube 500 to the supply tube 400 to flow into the ink storage unit 100 not into the inkjet head 700, the head valve 410, which is a 3-way valve, connects the injection tube 500 and an upper portion (at the ink storage unit) of the supply tube 400 to each other.

In order to prevent a pressure of gas filled in the ink storage unit 100 from interfering the injection of ink, the gas valve 310 is opened.

As described above, ink injected through the injection tube by operations of valves may be filled in the ink storage unit.

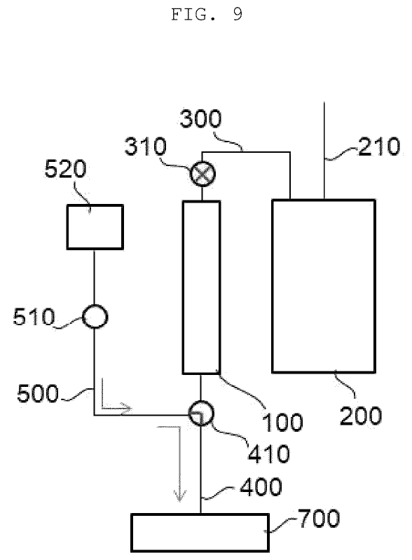

FIG. 9 is a view illustrating an operation of each valve in a process of directly supplying ink to the inkjet head from the schematic view shown in FIG. 7.

FIG. 9 is an operation that may be performed when ink is supplied to the inkjet head 700 in the initial preparation process or purge process of the inkjet printer.

First, the injection valve 510 is opened for ink to be injected through the injection tube 500.

In order to allow the ink that arrives from the end of the injection tube 500 to the supply tube 400 to flow into the inkjet head 700, the head valve 410, which is a 3-way valve, connects the injection tube 500 and a lower portion (at the inkjet head) of the supply tube 400 to each other.

At this point, it is not necessary, it is possible to additionally prevent the injected ink from flowing into the ink storage unit 100 by preventing ink from flowing the ink storage unit 100 by pressure of gas filled in into the ink storage unit 100 by closing the gas valve 310.

As described above, ink injected through the injection tube by operations of valves may be filled in the inkjet head.

The initial preparation process of the inkjet printer is performed by, from when an initial state where ink is not completely supplied both the ink storage unit 100 and the inkjet head 700, supplying ink into the ink storage unit 100 and the inkjet head 700.

Conventionally, the initial preparation of the inkjet printer is performed by supplying ink into the ink storage unit 100 first and transferring the ink supplied to the ink storage unit 100 into the inkjet head 700. However, in the case in which the ink storage space is small like the present disclosure, there is a problem in that the process of supplying ink stored in the ink storage unit back into the inkjet printer takes a long time.

As shown in FIG. 9, the present disclosure is configured such that ink injected into the injection tube flows directly to the inkjet head through the supply tube, so a problem caused by a small space in the ink storage unit can be solved.

Meanwhile, both the operations of FIGS. 8 and 9 should be performed in the initial preparation process of the inkjet printer, and the order of the operations is not specified. Moreover, while the ink storage unit is filled partially by the operation of FIG. 8, ink is supplied to the inkjet head by the operation of FIG. 9, and finally, the operation of FIG. 8 is performed again to fill ink into the ink storage unit. The process of switching into the operation of FIG. 8 from the state when the operation of FIG. 9 is performed to fill the ink storage unit partially may be performed in order of closing the gas valve 310 first and then opening the head valve 410.

Furthermore, the gas buffer-type micro-ink storage device of the present disclosure may be received with ink by using a syringe, and in the process of injecting ink by using a syringe, ink stored in the syringe may be exhausted. In this case, the syringe may be replaced when the injection valve 510 is closed, and in some cases, the syringe may be replaced when all valves are closed.

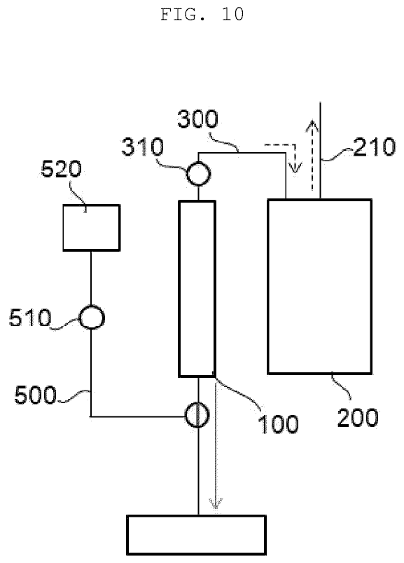

FIG. 10 is a view illustrating an operation of each valve in a process of performing inkjet printing from the schematic view shown in FIG. 7.

First, the injection valve 510 is closed to prevent the ink storage unit 100 from being connected to the outside space through the injection tube 500 and to seal the ink storage unit 100.

In order to allow ink in the ink storage unit 100 to flow into the inkjet head 700, the head valve 410 connects an upper portion (at the ink storage unit) of the supply tube 400 and a lower portion (at the inkjet head) to each other.

Furthermore, the gas valve 310 is opened so that the gas pressure control part connected to the pressure control tube 210 of the gas buffer unit 200 controls the internal pressure of the ink storage unit 100 and the inkjet head 700.

The operations of the valves as described above allow ink of the ink storage unit to be supplied into the inkjet head, and the gas pressure control device applies negative pressure, performing precise inkjet printing.

An inkjet printer according to another embodiment of the present disclosure is characterized to include a buffer type ink storage device with the above-described structure.

Other configurations may be applied in various ways within a range that does not harm the properties of the present disclosure.

Hereinabove, the present disclosure has been described with reference to the preferred embodiment. Although the preferred embodiment of the present disclosure has been described for illustrative purposes, those skilled in the art will appreciate that various modifications, additions and substitutions are possible, without departing from the scope and spirit of the present disclosure as disclosed in the accompanying claims. Therefore, the protection scope of the present disclosure should be interpreted by the matters described in the accompanying claims, not by a specific embodiment, and all technical ideas within the equivalent scope should be construed as being included in the scope of the present disclosure.

What is claimed is:

1. A gas buffer-type micro-ink storage device storing ink supplied to an inkjet head of an inkjet printer, the ink storage device comprising:
an ink storage unit storing ink;
a gas buffer unit that is connected to the ink storage unit with a gas connection tube through which gas flows, and connected to a gas pressure control device with a pressure control tube so that the gas pressure control device provides a gas volume to adjust gas pressure;
a gas valve that is enabled to adjust connection between the ink storage unit and the gas buffer unit;
a supply tube configured to supply the ink stored in the ink storage unit to the inkjet head;
a head valve configured to adjust connection between the ink storage unit and the inkjet head;
an injection tube configured to inject ink into the ink storage device; and
an injection valve configured to open and close the injection tube,
wherein the injection tube is connected to the supply tube or at least to a portion where the supply tube and the ink storage unit are connected to each other, and
according to operation of the head valve, ink injected into the injection tube does not flow into the ink storage unit but is injected into the inkjet head.

2. The gas buffer-type micro-ink storage device of claim 1, wherein in the supply tube, the head valve is installed to a position close to the inkjet head rather than a position to which the injection tube is connected, and
the head valve is a 2-way valve.

3. The gas buffer-type micro-ink storage device of claim 2, wherein when ink is injected through the injection tube with the head valve closed, the ink injected into the injection tube is injected into the ink storage unit, and
when ink is injected through the injection tube with the head valve opened and the gas valve closed, the ink injected into the injection tube does not flow into the ink storage unit but is injected into the inkjet head.

4. The gas buffer-type micro-ink storage device of claim 1, wherein in the supply tube, the head valve is installed at a position to which the injection tube is connected, and
the head valve is a 3-way valve.

5. The gas buffer-type micro-ink storage device of claim 4, wherein when the head valve connects the injection tube and the ink storage unit to each other, ink injected into the injection tube is injected into the ink storage unit, and
when the head valve connects the injection tube and the inkjet head to each other, the ink injected into the injection tube does not flow into the ink storage unit but is injected into the inkjet head.

6. The gas buffer-type micro-ink storage device of claim 1, further comprising:
an ink discharge tube configured to discharge ink flowing into the gas buffer unit outward, and a discharge valve configured to open and close the ink discharge tube.

7. An inkjet printer comprising a gas buffer-type micro-ink storage device, the inkjet printer comprising an inkjet head, a micro-ink storage device configured to supply ink to the inkjet head, and a gas pressure control device configured to control gas pressure in the micro-ink storage device,
wherein the micro-ink storage device is a gas buffer-type micro-ink storage device comprising:
an ink storage unit storing ink;
a gas buffer unit that is connected to the ink storage unit with a gas connection tube through which gas flows, and connected to the gas pressure control device with a pressure control tube so that the gas pressure control device provides a gas volume to adjust gas pressure;
a gas valve that is enabled to adjust connection between the ink storage unit and the gas buffer unit;
a supply tube configured to supply the ink stored in the ink storage unit to the inkjet head;
a head valve configured to adjust connection between the ink storage unit and the inkjet head;
an injection tube configured to inject ink into the ink storage device; and
an injection valve configured to open and close the injection tube,
wherein the injection tube is connected to the supply tube or at least to a portion where the supply tube and the ink storage unit are connected to each other, and
according to operation of the head valve, ink injected into the injection tube does not flow into the ink storage unit but is injected into the inkjet head.

8. The inkjet printer of claim 7, wherein in the supply tube, the head valve is installed at a position close to the inkjet head rather than a position to which the injection tube is connected, and
the head valve is a 2-way valve.

9. The inkjet printer of claim 8, wherein when ink is injected through the injection tube with the head valve closed, the ink injected into the injection tube is injected into the ink storage unit, and
when ink is injected through the injection tube with the head valve opened and the gas valve closed, the ink injected into the injection tube does not flow into the ink storage unit but is injected into the inkjet head.

10. The inkjet printer of claim 7, wherein in the supply tube, the head valve is installed at a position to which the injection tube is connected, and
the head valve is a 3-way valve.

11. The inkjet printer of claim 10, wherein when the head valve connects the injection tube and the ink storage unit to each other, the ink injected into the injection tube is injected into the ink storage unit, and
when the head valve connects the injection tube and the inkjet head to each other, the ink injected into the injection tube does not flow into the ink storage unit but is injected into the inkjet head.

12. The inkjet printer of claim 7, further comprising:
an ink discharge tube configured to discharge ink flowing into the gas buffer unit outward, and a discharge valve configured to open and close the ink discharge tube.
